(19) United States
(12) Patent Application Publication
(10) Pub. No.: US 2011/0016938 A1
(43) Pub. Date: Jan. 27, 2011

(54) Lock Status Indicator Device

(76) Inventor: Yi-Ting Chi, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/509,599

(22) Filed: Jul. 27, 2009

(51) Int. Cl. E05B 41/00

(52) U.S. Cl. 70/432

(57) ABSTRACT

A lock status indicator device (10) includes a base (12) secured to an outer surface (26) of a door (24) with a door lock (30). The door lock (30) includes a bolt (32) moveable between an extended, latching position and a retracted, unlatching position. A slider (14) is slideably mounted to the base (12) and includes first and second indicators (59, 65) on an outer face (56) of the slider (14) for indicating the door (24) is in a locked status not allowing the bolt (32) to be retracted from the latching position to the unlatching position or in an unlocked status allowing the bolt (32) to be retracted from the latching position to the unlatching position. A cam (16) is pivotably mounted to the base (12) and includes a guiding slot (61) through which a protrusion (58) of the slider (14) slideably extends. A shaft (18) is engaged with the cam (16) and operably connected to a turnknob (33) of the door lock (30). The shaft (18) jointly rotates with the cam (16) in response to operation of the turnknob (33), which, in turn, moves slider (14).

### BACKGROUND OF THE INVENTION

The present invention relates to a lock status indicator device and, more particularly, to a lock status indicator device for indicating a status of a door to which a door lock is mounted.

A typical door lock include at least one bolt (a latch bolt and/or a deadbolt) moveable between an extended, latching position and a retracted, unlatching position for latching a door to which the door lock is mounted. A turnknob or a button is mounted to an inner surface of the door, allowing locking of the door by operating the turnknob from the inside of the door. A key cylinder is mounted to an outer surface of the door, allowing unlocking of the door by operation of the key cylinder with a key from the outside of the door. Furthermore, it is known to provide the door lock, especially a door lock mounted to such as a door of a hotel room, a public lavatory or a public bathroom, with a status indicator device to indicate the door is locked or unlocked. Specifically, a room guest of a hotel or a user of a public lavatory or bathroom can operate the status indicator device through turning of the turnknob to indicate the door is in a locked state (the room is occupied) or an unlocked state (the room is vacant) so that the room guest or the user will not be disturbed when desired, and people outside of the room can easily realize that the room is occupied and, thus, will not forcibly rotate a handle of the door lock, preventing the handle and interior members of the door lock from being damaged.

However, conventional status indicator devices for door locks are generally mounted in casings of the door locks, requiring extensive modification to the structure of the door locks and, thus, resulting in difficulties in assembly. In addition, the status indicator devices may be easily damaged resulting from forcible rotation of the handles of the door locks, leading to shortened service life. Further, the status indicator devices must be replaced together with the door locks if the door locks are damaged. Furthermore, it is inconvenient for people outside of the public lavatories or bathrooms to unlock the door locks when an emergency situation occurs, for the door locks used in the public lavatories or bathrooms generally are not provided with key cylinders. Even if key cylinders are provided, the keys are not always readily available such that the door locks or the status indicator devices have to be destroyed when in the emergency situation.

Thus, a need exists for a lock status indicator device that can indicate a status of a door while allowing separate assembly to the door lock.

### BRIEF SUMMARY OF THE INVENTION

The present invention solves this need and other problems in the field of status indicator devices for locks by providing, in a preferred form, a lock status indicator device including a base having a mounting plate. The mounting plate includes inner and outer sides spaced along a first axis. The inner side of the mounting plate is secured to an outer surface of a door provided with a door lock. The door lock includes a bolt moveable between an extended, latching position and a retracted, unlatching position. The door lock further includes a turnknob operably to lock or unlock the bolt in the latching position. The mounting plate further includes upper and lower ends spaced along a second axis perpendicular to the first axis. The mounting plate further includes a shaft hole and a sliding slot both extending from the inner side through the outer side thereof. A slider is slideably mounted to the base along the second axis and includes inner and outer faces spaced along the first axis. The inner face of the slider is intermediate the outer side of the mounting plate and the outer face of the slider. The slider further includes a protrusion formed on the inner face and moveably received in the sliding slot of the mounting plate along the second axis. The slider further includes first and second indicators on the outer face thereof for indicating the door is locked or unlocked. A cam is pivotably mounted to the base and intermediate the mounting plate and the slider along the first axis. The cam includes an arcuate guiding slot through which the protrusion of the slider slideably extends. The guiding slot is eccentric to the shaft hole of the base. The lock status indicator device further includes a shaft extending through the shaft hole of the mounting plate and having first and second ends spaced along the first axis. The shaft further includes an intermediate section intermediate the first and second ends along the first axis and rotatably received in the shaft hole of the mounting plate. The intermediate section of the shaft is engaged with the cam to allow joint rotation of the shaft and the cam. The first end of the shaft is extended into the door and operably connected to the turnknob so that the shaft rotates together with the cam through the operation of the turnknob. A cover covers the base and includes a face plate. The face plate includes a window selectively aligned with one of the first and second indicators of the slider. When the door is in a locked status not allowing the bolt to be retracted from the latching position to the unlatching position, one of the first and second indicators on the outer surface of the slider is aligned with the window of the cover. When the door is in an unlocked status allowing the bolt to be retracted from the latching position to the unlatching position, the other one of the first and second indicators on the outer surface of the slider is aligned with the window of the cover.

In a preferred form, the mounting plate further includes first and second sides extending between the upper and lower ends and spaced along a third axis perpendicular to the first and second axes. The mounting plate further includes first and second wings extending perpendicularly from the first and second sides along the first axis. The first and second wings together define a track therebetween. The slider further includes first and second sides spaced along the third axis. The slider is slideably received in the track with the first and second sides of the slide slideably abutting the first and second wings of the mounting plate.

In a preferred form, the cam further includes a through-hole aligned with the shaft hole of the mounting plate. The intermediate section of the shaft extends through and is engaged in the through-hole of the cam. The guiding slot of the cam includes first and second ends spaced along the second and third axes. A first spacing between the first end of the guiding slot and the through-hole along the third axis is less than a second spacing between the second end of the guiding slot and the through-hole along the second axis. The protrusion of the slider moves between the first and second end of the guiding slot along the guiding slot when the cam is rotated to indicate the corresponding state of the door. When the protrusion of the slider is in the first end of the guiding slot, one of the first and second indicators on the slider is aligned with the window of the cover to indicate the door is locked. When the protrusion of the slider is in the second end of the guiding slot, the other one of the first and second indicators on the slider is aligned with the window of the cover to indicate the door is unlocked.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows an exploded, perspective view of a lock status indicator device of a first embodiment according to the preferred teachings of the present invention.

FIG. 2 shows an exploded, perspective view of the lock status indicator device of FIG. 1 with the lock status indicator device mounted to a door provided with a door lock.

FIG. 3 shows a side view of the door, the door lock, and the lock status indicator device of FIG. 2.

FIG. 4 shows a cross sectional view of the lock status indicator device of FIG. 1.

FIG. 5 shows a cross sectional view of the lock status indicator device of FIG. 1 taken along section line 5-5 of FIG. 4.

FIG. 6 shows a cross sectional view similar to FIG. 4, with a shaft rotated and with a slider moved upward.

FIG. 7 shows a cross sectional view of the lock status indicator device of FIG. 1 taken along section line 7-7 of FIG. 6.

FIG. 8 shows a front view of the door, the door lock, and the lock status indicator device of FIG. 3.

FIG. 9 shows a front view similar to FIG. 8, with a turnknob rotated in a clockwise direction and with a locking plug moved leftward to engage with an actuating member.

FIG. 10 shows an exploded, perspective view of a lock status indicator device of a second embodiment according to the preferred teachings of the present invention with the lock status indicator device mounted to a door provided with a door lock.

FIG. 11 shows a cross sectional view of the lock status indicator device of FIG. 10.

FIG. 12 shows an exploded, perspective view of a lock status indicator device of a third embodiment according to the preferred teachings of the present invention with the lock status indicator device mounted to a door provided with a door lock.

FIG. 13 shows a side view of the door, the door lock, and the lock status indicator device of FIG. 12.

FIG. 14 shows an exploded, perspective view of a lock status indicator device of a fourth embodiment according to the preferred teachings of the present invention.

FIG. 15 shows a side view similar to FIG. 9, illustrating use of the lock status indicator device of FIG. 14 in a left-hand door.

FIG. 16 shows a cross sectional view of the lock status indicator device of FIG. 14 used in the left-hand door.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “side”, “end”, “portion”, “section”, “upper”, “lower”, “clockwise” “counterclockwise”, “spacing”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

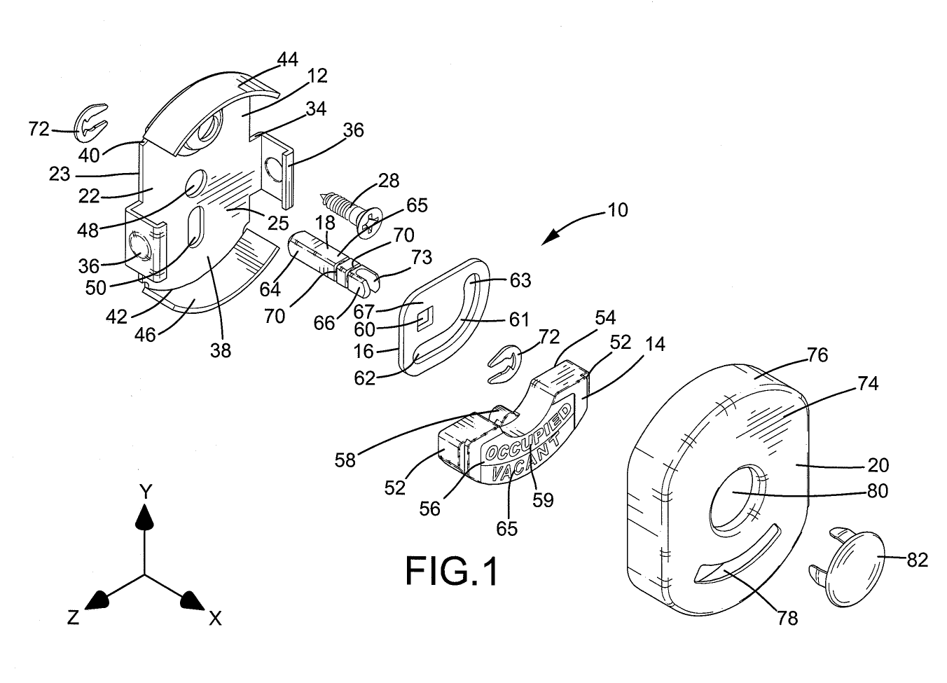

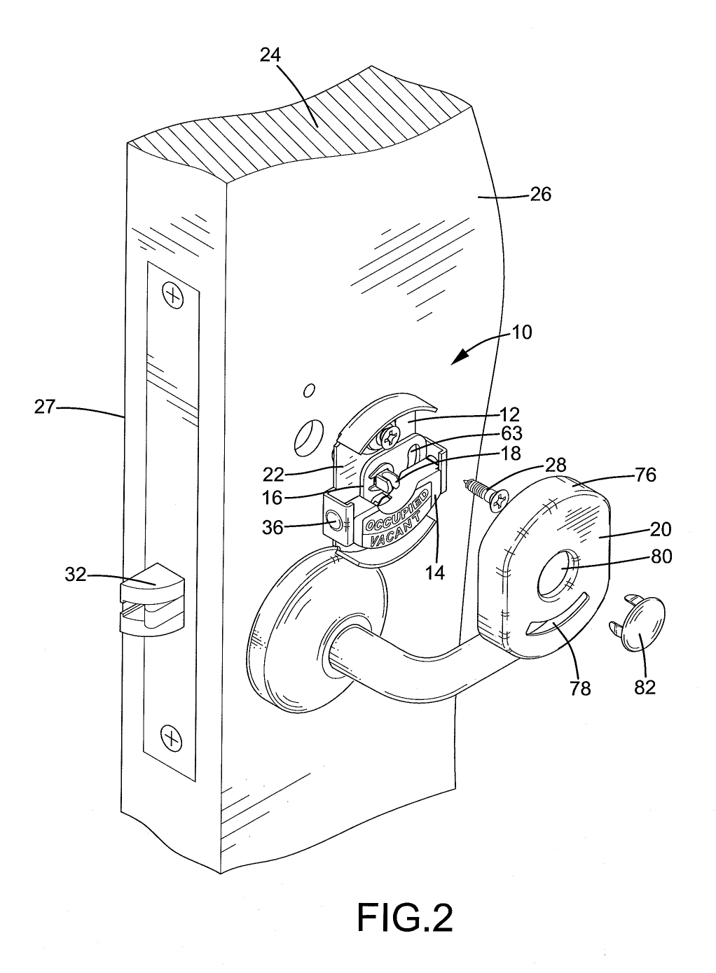

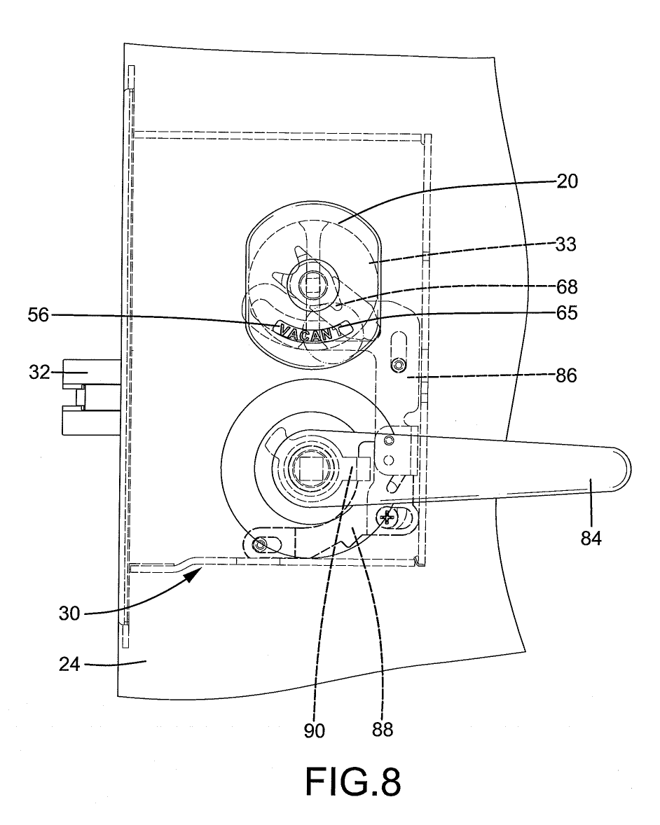

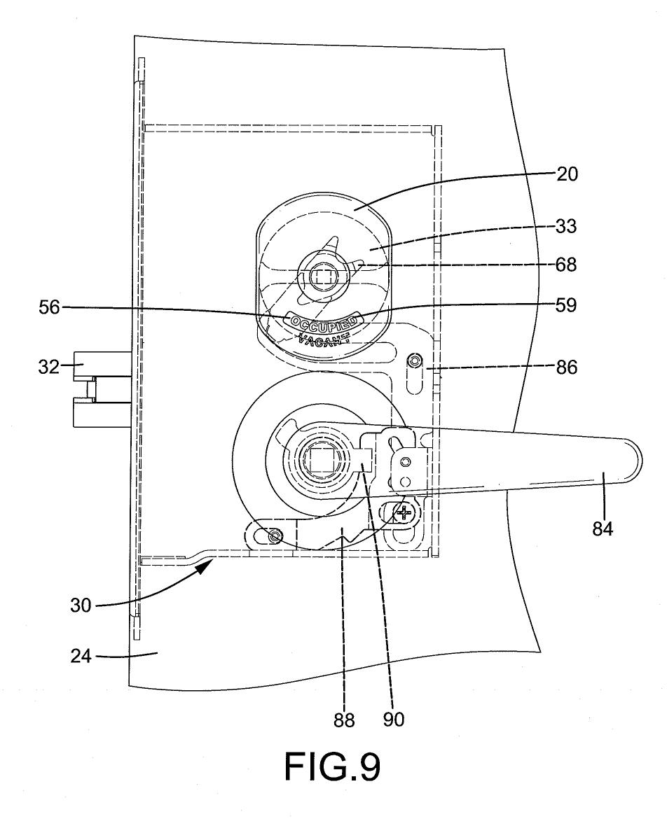

A lock status indicator device of a first embodiment according to the preferred teachings of the present invention is shown in FIGS. 1-9 of the drawings and generally designated 10. Lock status indicator device 10 can be mounted on an outer surface 26 of a door 24 to indicate door 24 is locked or unlocked. Door 24 is provided with a door lock 30 including a bolt 32 moveable between an extended, latching position and a retracted, unlatching position. Inside and outside handles 84 are respectively mounted to inner and outer surfaces 27 and 26 of door 24 and operable to retract bolt 32 from the latching position to the unlatching position through an actuating member 90 (FIG. 8). Door lock 30 further includes a turnknob 33, a pivotal member 68, a follower plate 86, and a locking plug 88. Turnknob 33 is mounted on inner surface 27 of door 24 and connected with pivotal member 68. Follower plate 86 is connected between pivotal member 68 and locking plug 88. When pivotal member 68 is rotated by operation of turnknob 33, follower plate 86 is moved downward or upward, which, in turn, moves locking plug 88 leftward to engage with actuating member 90 or rightward to disengage from actuating member 90, thereby locking or unlocking door 24 (FIGS. 9 and 8), which will be further described later. Door 24 can be a door of such as a hotel room, a public lavatory or a public bathroom. However, use of door lock 30 on other doors would be within the skill of the art.

Lock status indicator device 10 includes a base 12. Base 12 includes a mounting plate 22 including inner and outer sides 23 and 25 spaced along a first axis X. Inner side 23 of mounting plate 22 is secured to outer surface 26 of door 24 such as by a screw 28. Mounting plate 22 further includes upper and lower ends 40 and 42 spaced along a second axis Y perpendicular to first axis X. Mounting plate 22 further includes first and second sides 34 extending between upper and lower ends 40 and 42 and spaced along a third axis Z perpendicular to first and second axes X and Y. Two wings 36 respectively extend perpendicularly from first and second sides 34 along first axis X and together define a track 38 therebetween. Another two wings 44 and 46 respectively extend perpendicularly from upper and lower ends 40 and 42 along first axis X. Mounting plate 22 further includes a shaft hole 48 and a sliding slot 50 both extending from inner side 23 through outer side 25. Sliding slot 50 is intermediate shaft hole 48 and lower end 42 and extends along second axis Y.

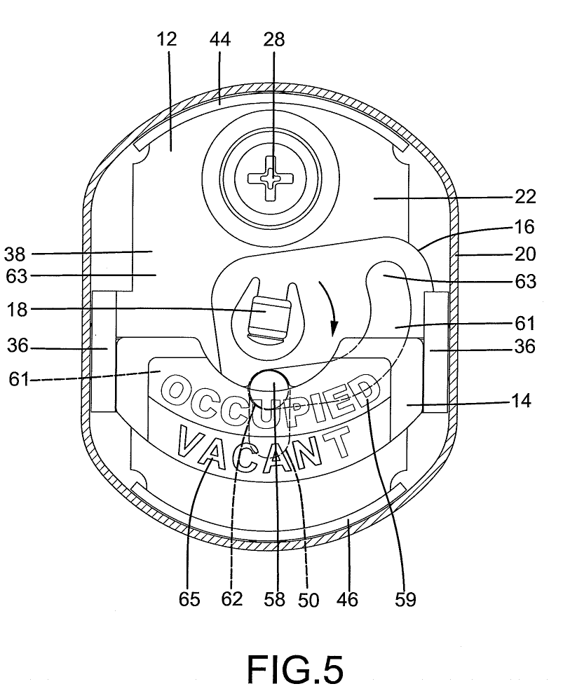

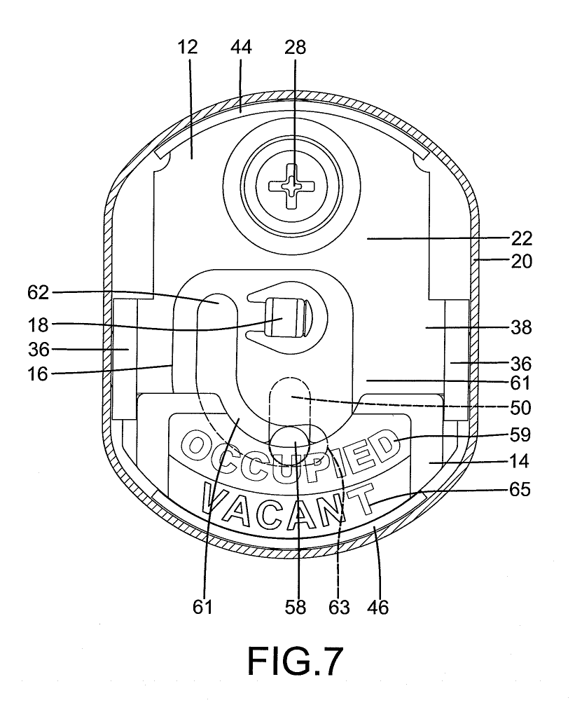

Lock status indicator device 10 further includes a slider 14. Slider 14 is mounted to base 12 and slideably received in track 38 of base 12 along second axis Y. Slider 14 includes first and second sides 52 spaced along third axis Z and slideably abutting wings 36 of first and second sides 34 of mounting plate 22. Slider 14 further includes inner and outer faces 54 and 56 spaced along first axis X with inner face 54 of slider 14 intermediate outer side 25 of mounting plate 22 and outer face 56 of slider 14. A protrusion 58 is formed on inner face 54 of slider 14 and moveably received in sliding slot 50 of mounting plate 22 along second axis Y First and second indicators 59 and 65 are provided on outer face 56 of slider 14 (FIGS. 5 and 7). Examples of the indicators include, but not limited to, colors such as green and red, patterns and characters. In the preferred form shown in FIGS. 1-9, first indicator 59 is above second indicator 65 along second axis Y and includes characters shown as “occupied” while second indicator 65 includes characters shown as “vacant”.

Lock status indicator device 10 further includes a cam 16. Cam 16 is pivotably mounted to base 12 and intermediate mounting plate 22 and slider 14 along first axis X. Cam 16 includes a through-hole 60 aligned with shaft hole 48 of mounting plate 22 and having non-circular cross sections. Examples of the shapes of the cross sections of through-hole 60 include square, hexagonal, and octagonal, etc. In the preferred form shown in FIGS. 1-9, through-hole 60 has square cross sections. Cam 16 further includes an arcuate guiding slot 61 through which protrusion 58 of slider 14 slideably extends. Guiding slot 61 is eccentric to through-hole 60 of cam 16 and shaft hole 48 of base 12 and includes first and second ends 62 and 63 spaced along second and third axes Y and Z. A first spacing between first end 62 of guiding slot 61 and through-hole 60 of cam 16 along third axis Z is less than a second spacing between second end 63 of guiding slot 61 and through-hole 60 of cam 16 along second axis Y.

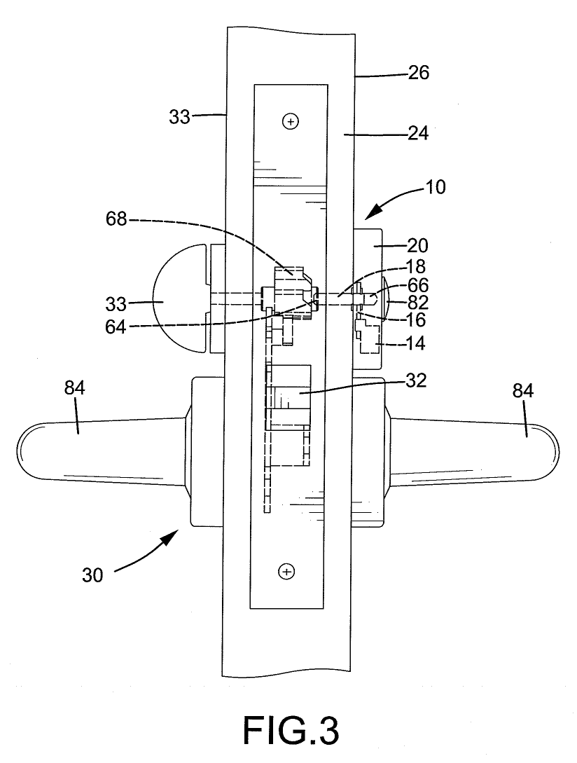

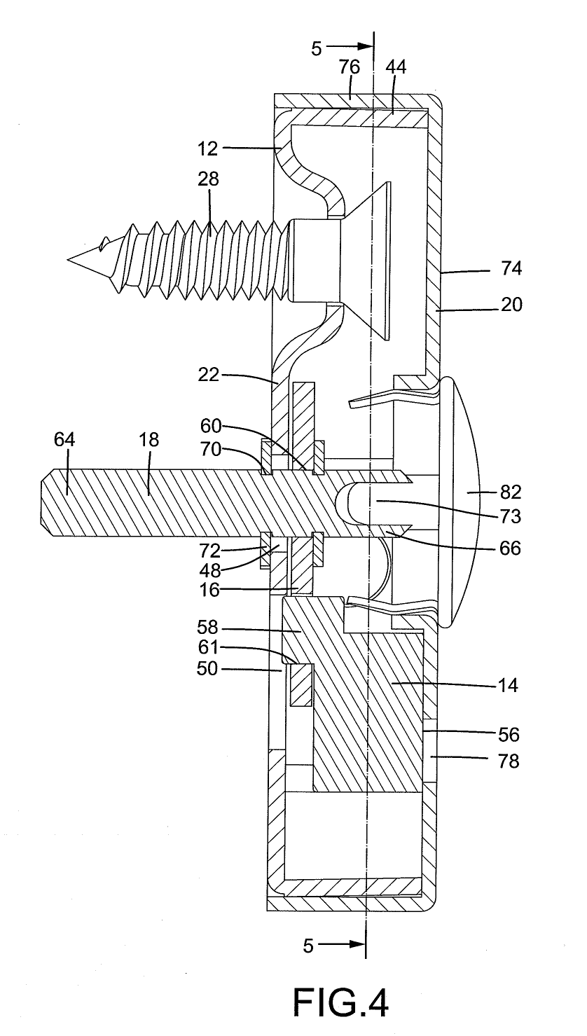

Lock status indicator device 10 further includes a shaft 18. Shaft 18 includes first and second ends 64 and 66 spaced along first axis X and an intermediate section 65 intermediate first and second ends 64 and 66 along first axis X. Shaft 18 extends through shaft hole 48 of mounting plate 22 and through-hole 60 of cam 16, with intermediate section 65 rotatably received in shaft hole 48 of mounting plate 22 and non-rotatably engaged in through-hole 60 of cam 16 to allow joint rotation of shaft 18 and cam 16. In the preferred form shown in FIGS. 1-9, intermediate section 65 of shaft 18 has cross sections the same as through-hole 60 of cam 16 and includes two spaced annual grooves 70 respectively located near inner side 23 of mounting plate 22 and an outer face 67 of cam 16 (see FIG. 4). Two retainer rings 72 are respectively mounted in annual grooves 70, preventing displacement of shaft 18 along first axis X. First end 64 of shaft 18 is extended into door 24 and connected to pivotal member 68 so that shaft 18 rotates together with cam 16 when turnknob 33 is turned (see FIG. 3). Further, a notch 73 is formed in an end face of second end 66 of shaft 18.

Lock status indicator device 10 further includes a cover 20. Cover 20 covers base 12 and includes a face plate 74 and a peripheral wall 76 extending perpendicularly from face plate 74 along first axis X. Face plate 74 includes a window 78 selectively aligned with one of first and second indicators 59 and 65 of slider 14. Face plate 74 further includes an opening 80 in alignment with notch 73 of shaft 18, and a lid 82 is removably coupled to opening 80 for shielding purposes. A tool such as a screwdriver can be extended through opening 80 and into notch 73 of shaft 18 to rotate shaft 18 from the outside of door 24 when lid 82 is removed from opening 80. Peripheral wall 76 of cover 20 surrounds wings 36, 44 and 46 of base 12 to enclose slider 14 and cam 16 in base 12 when cover 20 covers base 12.

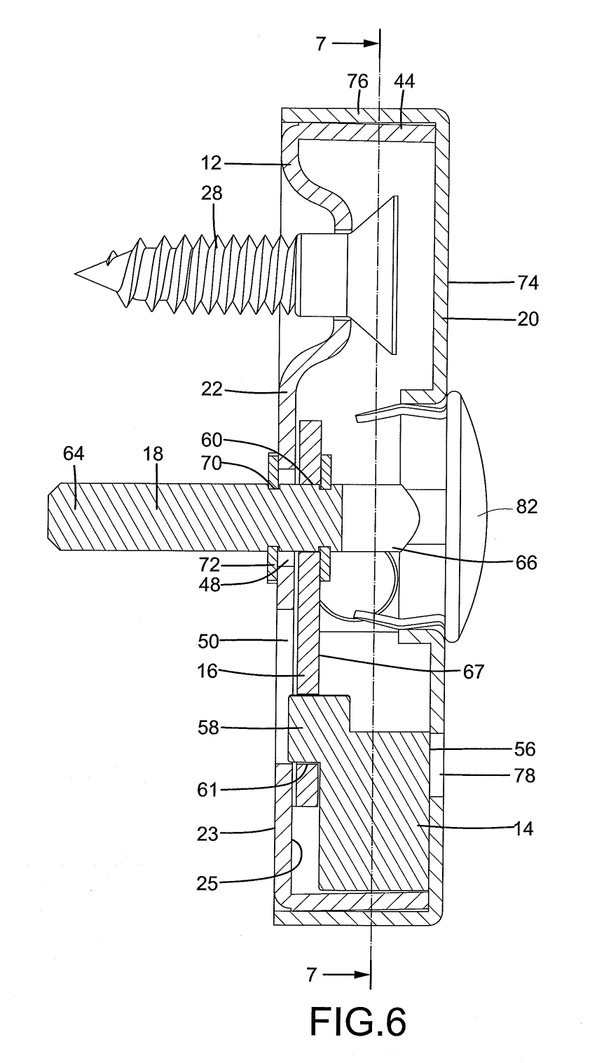

In operation, when turnknob 33 is turned, slider 14 slides between a first position in which first indicator 59 on slider 14 is aligned with window 78 of cover 20 to indicate door 24 is in a locked status not allowing bolt 32 to be retracted from the latching position to the unlatching position and a second position in which second indicator 65 on slider 14 is aligned with window 78 of cover 20 to indicate door 24 is in an unlocked status allowing bolt 32 to be retracted from the latching position to the unlatching position. Specifically, since guiding slot 61 is eccentric to through-hole 60 of cam 16 and since protrusion 58 of slider 14 is moveably received in sliding slot 50 of mounting plate 22 along second axis Y and slideably extends through guiding slot 61 of cam 16, shaft 18 is rotated when turnknob 33 is turned, causing rotation of cam 16 between a third position (FIG. 5) and a fourth position (FIG. 7) about shaft 18, which, in turn, causing downward/upward movement of protrusion 58 between shaft hole 48 and lower end 42 of base 12 along second axis Y and along guiding slot 61 between first and second ends 62 and 63 of guiding slot 61. With reference to FIGS. 4 and 5, when door 24 is unlocked, protrusion 58 of slider 14 is in first end 62 of guiding slot 61 and second indicator 65 on slider 14 is aligned with window 78 of cover 20 to indicate door 24 is unlocked. With reference to FIGS. 6 and 7, when door 24 is locked, protrusion 58 of slider 14 is in second end 63 of guiding slot 61 and first indicator 59 on slider 14 is aligned with window 78 of cover 20 to indicate door 24 is locked. Specifically, when turnknob 33 of FIG. 8 is rotated in a clockwise direction to lock door 24, pivotal member 68 and shaft 18 are rotated together, causing downward movement of follower plate 86 and slider 14, which, in turn, moves locking plug 88 leftward to engage with actuating member 90 (FIG. 9), blocking rotation of inside and outside handles 84 and preventing movement of bolt 32 from the latching position to the unlatching position. Thus, door 24 is locked, and first indicator 59 on slider 14 is aligned with window 78 of cover 20 to indicate door 24 is in the locked status. On the other hand, when turnknob 33 of FIG. 9 is rotated in a counterclockwise direction to unlock door 24, pivotal member 68 and shaft 18 are rotated together, causing upward movement of follower plate 86 and slider 14, which, in turn, moves locking plug 88 rightward to disengage from actuating member 90 (FIG. 8), allowing rotation of inside and outside handles 84 to retract bolt 32 from the latching position to the unlatching position. Thus, door 24 is unlocked, and second indicator 65 on slider 14 is aligned with window 78 of cover 20 to indicate door 24 is in the unlocked status.

As discussed above, lock status indicator device 10 according to the preferred teachings of the present invention can indicate door 24 is locked or unlocked while allowing separate assembly to door lock 30. Thus, lock status indicator device 10 according to the preferred teachings of the present invention can be utilized with door lock of any desired type. Further, in a emergency situation that a person locking the door lock with the status indicator device is not capable of unlocking the door lock from the inside of the room, people outside of the room can extend a tool through opening 80 and into notch 73 of shaft 18 to rotate shaft 18, unlocking the door 24 to help the person.

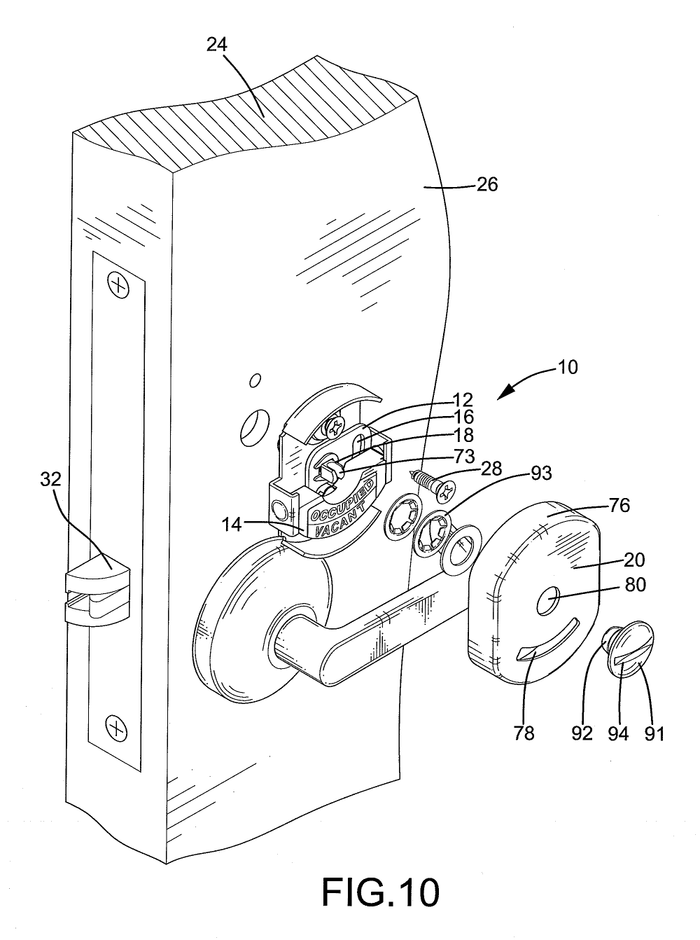

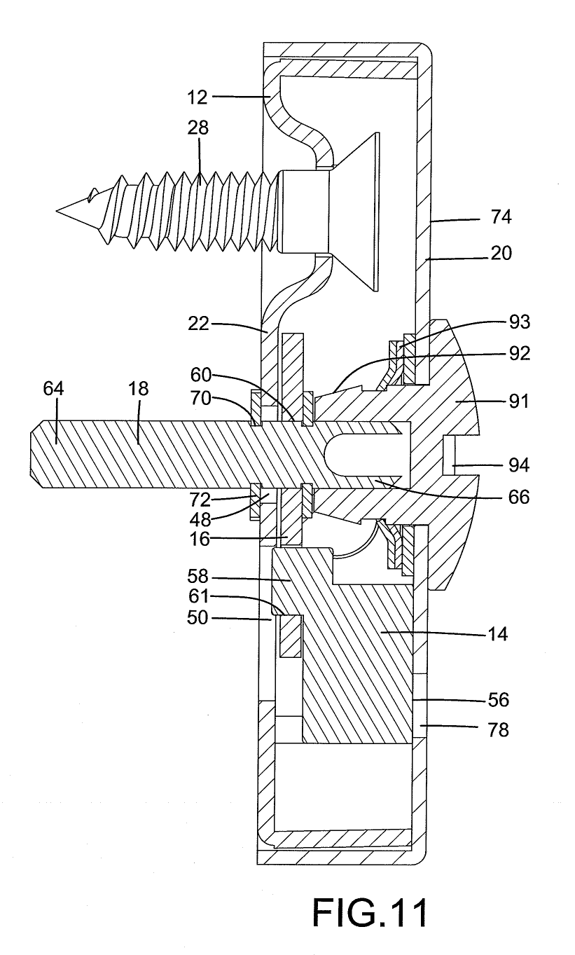

FIG. 10 and FIG. 11 show a lock status indicator device 10 of a second embodiment modified from the first embodiment. Description of the parts of lock status indicator device 10 shown in FIGS. 10 and 11 identical to those shown in FIGS. 1 through 9 is omitted. In particular, an operational member 91 is coupled to opening 80 instead of lid 82. Operational member 91 includes an inner end 92 extending through opening 80 and engaged with second end 66 of shaft 18 by clips 93 so that shaft 18 is rotatable by rotating operational member 91 from the outside of door 24. Further, operational member 91 includes a slot 94 in an outer face thereof allowing insertion of a tool or a coin to rotate shaft 18 for unlocking bolt 32 from the outside of door 24 when in an emergency situation. It can be appreciated that second end 66 of shaft 18 does not have to include notch 73 and that slot 94 can be of other forms and shapes for coupling differing tools.

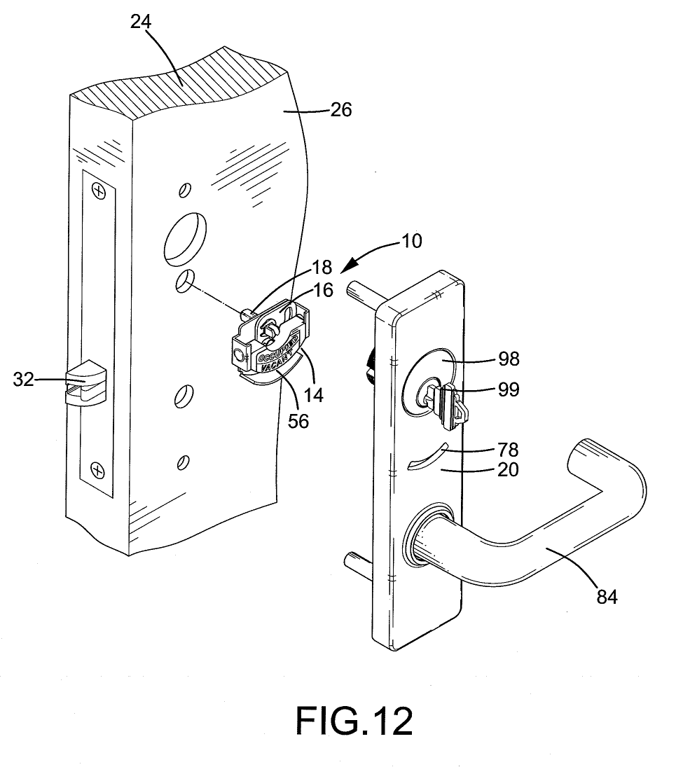

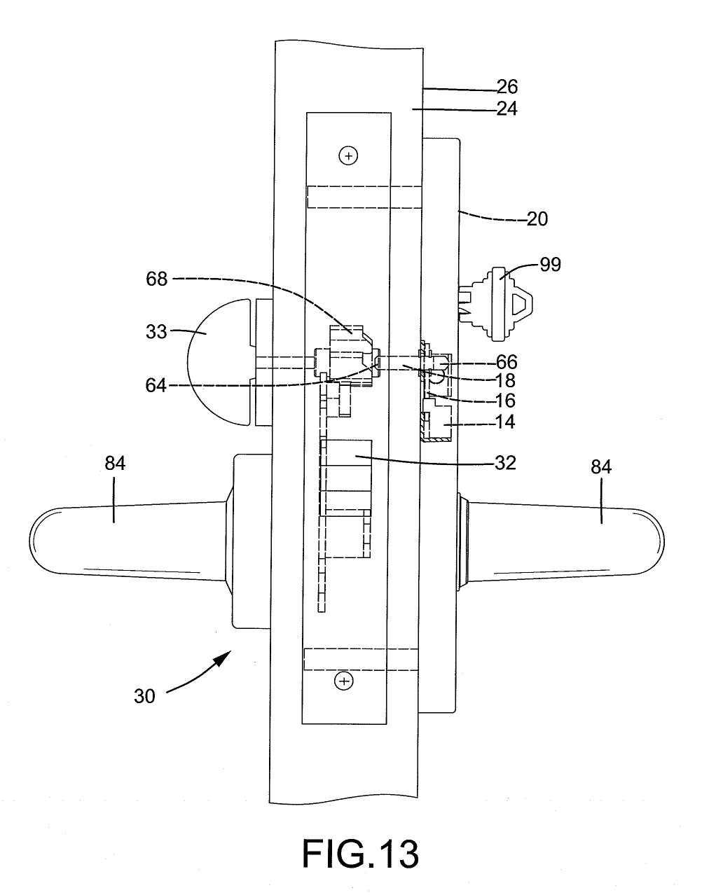

FIG. 12 and FIG. 13 show a lock status indicator device 10 of a third embodiment modified from the first embodiment. Description of the parts of lock status indicator device 10 shown in FIGS. 12 and 13 identical to those shown in FIGS. 1 through 9 is omitted. In particular, cover 20 further serves as a cover of door lock 30 and includes a key cylinder 98. key cylinder 98 is connected with pivotal member 68 so that a key 99 can be inserted into key cylinder 98 to rotate shaft 18 and to move locking plug 88 rightward/leftward, allowing unlocking of the door 24 by operation of key cylinder 98 from the outside of door 24.

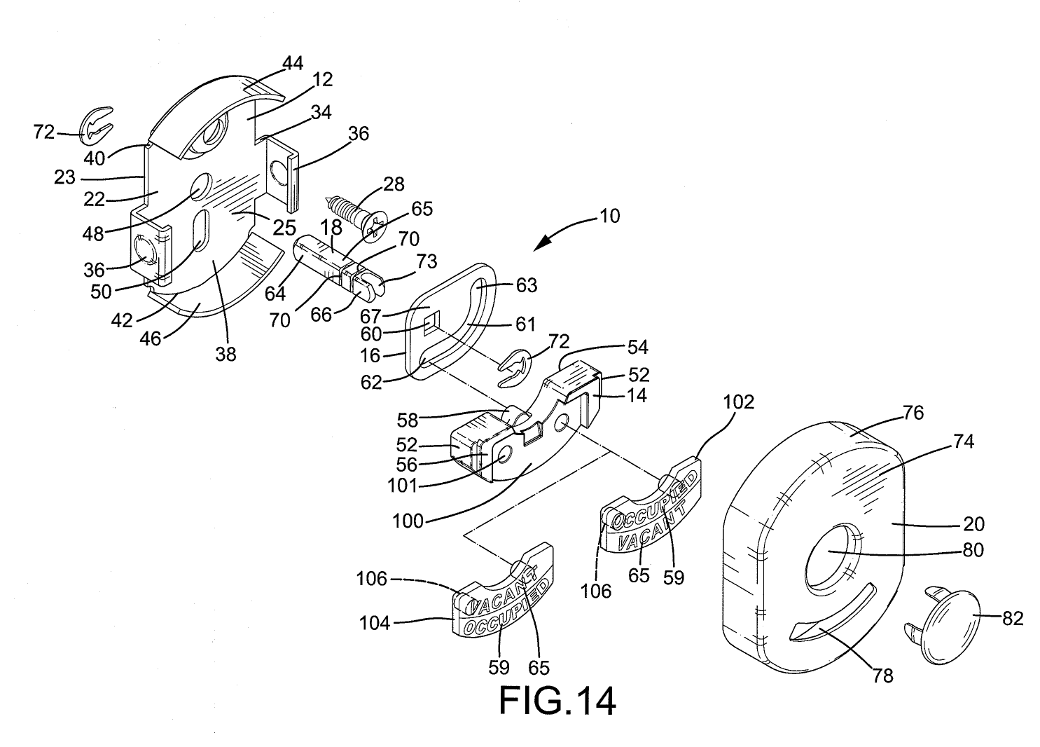

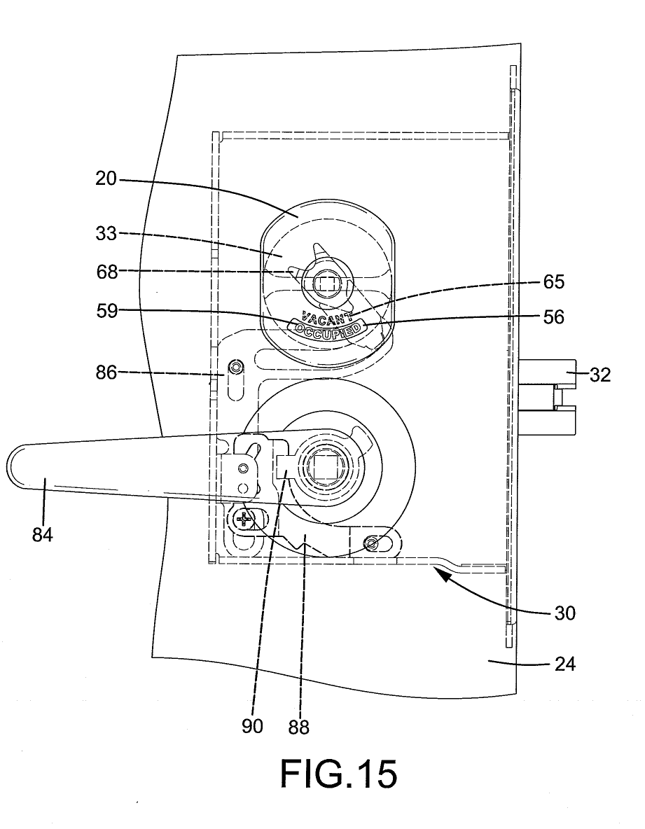

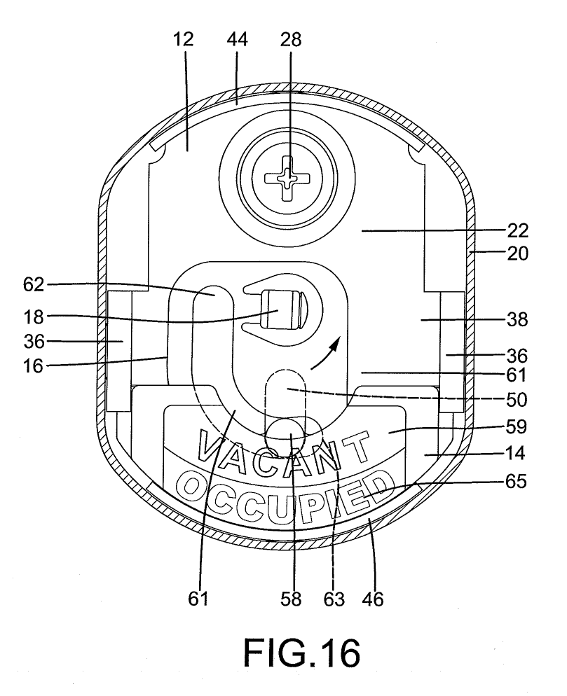

FIG. 14 shows a lock status indicator device 10 of a fourth embodiment according to the preferred teachings of the present invention. The parts of lock status indicator device 10 shown in FIG. 14 identical to those shown in FIGS. 1 through 9 are not described to avoid redundancy. In particular, a recessed portion 100 is formed in outer face 56 of slider 14 and includes two engaging holes 101. Lock status indicator device 10 further includes a first indicator plate 102 provided with two pegs 106 on an inner face thereof and first and second indicators 59 and 65 on an outer face thereof, with second indicator 65 below first indicator 59 along second axis Y. Lock status indicator device 10 further includes a second indicator plate 104 provided with two pegs 106 on an inner face thereof and first and second indicators 59 and 65 on an outer face thereof, with second indicator 65 above first indicator 59 along second axis Y. Each of first and second indicator plates 102 and 104 is detachably engaged to recessed portion 100 of outer face 56 of slider 14 by coupling pegs 106 with engaging holes 101, allowing lock status indicator device 10 to suit differently handed doors by optionally engaging one of first and second indicator plates 102 and 104 to outer face 56 of slider 14. Specifically, when first indicator plate 102 is engaged to outer face 56 of slider 14, lock status indicator device 10 can be utilized in right-hand door 24 as shown in FIGS. 5 and 9. Cam 16 is initially in the third position when door 24 is in the unlocked status (FIG. 5). Cam 16 is in the fourth position when door 24 is in the locked status (FIG. 7). On the other hand, when second indicator plate 104 is engaged to outer face 56 of slider 14, lock status indicator device 10 can be utilized in a left-hand door 24 as shown in FIG. 15 and 16. Cam 16 is initially in the fourth position when door 24 is in the unlocked status (FIG. 16). Cam 16 is in the third position when door 24 is in the locked status. Specifically, when turnknob 33 of FIG. 15 is rotated in a counterclockwise direction to lock door 24, pivotal member 68 and shaft 18 are rotated together, causing downward movement of follower plate 86 and causing rotation of cam 16 between the third position and the fourth position about shaft 18. Slider 14 is moved upward through rotation of cam 16. Locking plug 88 is moved rightward to engage with actuating member 90 through downward movement of follower plate 86. Thus, door 24 is locked, and first indicator 59 on slider 14 is aligned with window 78 of cover 20 to indicate door 24 is in the locked status.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims.

1. A lock status indicator device comprising, in combination:
a base (12) including a mounting plate (22) including inner and outer sides (23, 25) spaced along a first axis (X), with the inner side (23) of the mounting plate (22) being adapted to be secured to an outer surface (26) of a door (24) provided with a door lock (30), with the door lock (30) including a bolt (32) moveable between an extended, latching position and a retracted, unlatching position, with the door lock (30) further including a turnknob (33) operably to lock or unlock the bolt (32) in the latching position, with the mounting plate (22) further including upper and lower ends (40, 42) spaced along a second axis (Y) perpendicular to the first axis (X), with the mounting plate (22) further including a shaft hole (48) and a sliding slot (50) both extending from the inner side (23) through the outer side (25);
a slider (14) slideably mounted to the base (12) along the second axis (Y) and including inner and outer faces (54, 56) spaced along the first axis (X), with the inner face (54) of the slider (14) intermediate the outer side (25) of the mounting plate (22) and the outer face (56) of the slider (14), with the slider (14) further including a protrusion (58) formed on the inner face (54) and moveably received in the sliding slot (50) of the mounting plate (22) along the second axis (Y), with the slider (14) further including first and second indicators (59, 65) on the outer face (56) for indicating the door (24) is in a locked status not allowing the bolt (32) to be retracted from the latching position to the unlatching position or in a unlocked status allowing the bolt (32) to be retracted from the latching position to the unlatching position;
a cam (16) pivotably mounted to the base (12), with the cam (16) intermediate the mounting plate (22) and the slider (14) along the first axis (X), with the cam (16) including an arcuate guiding slot (61) through which the protrusion (58) of the slider (14) slideably extends, with the guiding slot (61) being eccentric to the shaft hole (48) of the base (12);
a shaft (18) extending through the shaft hole (48) of the mounting plate (22), with the shaft (18) including first and second ends (64, 66) spaced along the first axis (X), with the shaft (18) further including an intermediate section (65) intermediate the first and second ends (64, 66) along the first axis (X) and rotatably received in the shaft hole (48) of the mounting plate (22), with the intermediate section (65) of the shaft (18) being engaged with the cam (16) to allow joint rotation of the shaft (18) and the cam (16), with the first end (64) of the shaft (18) being adapted to be extended into the door (24) and operably connected to the turnknob (33) so that the shaft (18) rotates together with the cam (16) through the operation of the turnknob (33); and
a cover (20) covering the base (12) and including a face plate (74) including a window (78), with the window (78) selectively aligned with one of the first and second indicators (59, 65) of the slider (14),
wherein when the door (24) is in the locked status, one of the first and second indicators (59, 65) on the outer surface (56) of the slider (14) is aligned with the window (78) of the cover (20) to indicate the door (24) is locked; and
wherein when the door (24) is in the unlocked status, the other one of the first and second indicators (59, 65) on the outer surface (56) of the slider (14) is aligned with the window (78) of the cover (20) to indicate the door (24) is unlocked.

2. The lock status indicator device as claimed in claim 1, with the mounting plate (22) further including first and second sides (34) extending between the upper and lower ends (40, 42) and spaced along a third axis (Z) perpendicular to the first and second axes (X, Y), with the mounting plate (22) further including first and second wings (36) extending perpendicularly from the first and second sides (34) along the first axis (X), with first and second wings (36) together defining a track (38) therebetween, with the slider (14) further including first and second sides (52) spaced along the third axis (Z), with the slider (14) slideably received in the track (38), and with the first and second sides (52) of the slider (14) slideably abutting the first and second wings (36) of the mounting plate (22).

3. The lock status indicator device as claimed in claim 2, with the sliding slot (50) intermediate the shaft hole (48) and the lower end (42) of the base (12) along the second axis (Y), and with the slider (14) being moved between the shaft hole (48) and the lower end (42) of the base (12) along the second axis (Y) when the cam (16) rotates together with the shaft (18).

4. The lock status indicator device as claimed in claim 3, with the cam (16) further including a through-hole (60) aligned with the shaft hole (48) of the mounting plate (22), with the intermediate section (65) of the shaft (18) extending through and engaged in the through-hole (60) of the cam (16), with the guiding slot (61) of the cam (16) including first and second ends (62, 63) spaced along the second and third axes (Y, Z), with a first spacing between the first end (62) of the guiding slot (61) and the through-hole (60) along the third axis (Z) being less than a second spacing between the second end (63) of the guiding slot (61) and the through-hole (60) along the second axis (Y), with the protrusion (58) moving along the second axis (Y) and along the guiding slot (61) between the first and second ends (62, 63) of the guiding slot (61) when the cam (16) is rotated,
wherein when the protrusion (58) is in the first end (62) of the guiding slot (61), one of the first and second indicators (59, 65) on the slider (14) is aligned with the window (78) of the cover (20), and
wherein when the protrusion (58) is in the second end (63) of the guiding slot (61), the other one of the first and second indicators (59, 65) on the slider (14) is aligned with the window (78) of the cover (20).

5. The lock status indicator device as claimed in claim 3, with the mounting plate (22) further including third and fourth wings (44, 46) extending perpendicularly from the upper and lower ends (40, 42) along the first axis (X), with the cover (20) further including a peripheral wall (76) extending perpendicularly from the face plate (74) along the first axis (X), and with the peripheral wall (76) of the cover (20) surrounding the first, second, third and fourth wings (36, 44, 46) of the base (12).

6. The lock status indicator device as claimed in claim 2, with the shaft (18) further including a notch (73) formed in an end face of the second end (66) of the shaft (18), with the face plate (74) of the cover (20) further including an opening (80) in alignment with the notch (73), with a tool adapted to be extended through the opening (80) into the notch (73) to rotate the shaft (18) from the outside of the door (24), and with the cover (20) further including a lid (82) removably coupled to the opening (80).

7. The lock status indicator device as claimed in claim 2, with the face plate (74) of the cover (20) further including an opening (80) in alignment with the second end (66) of the shaft (18), with the cover (20) further including an operational member (91) coupled to the opening (80), with the operational member (91) having an inner end (92) extending through the opening (80) and engaged with the second end (66) of the shaft (18), and with the shaft (18) being rotatable by rotating the operational member (91) from the outside of the door (24).

8. The lock status indicator device as claimed in claim 2, with the cover (20) further including a key cylinder (98), and with a key (99) adapted to be inserted into the key cylinder (98) to rotate the shaft (18) from the outside of the door (24).

9. The lock status indicator device as claimed in claim 3, with the slider (14) including a recessed portion (100) in the outer face (56) of the slider (14), with the lock status indicator device (10) further comprising, in combination: first and second indicator plates (102, 104), each of the first and second indicator plates (102, 104) including the first and second indicators (59, 65), with the second indicator (65) of the first indicator plate (102) below the first indicator (59) of the first indicator plate (102) along the second axis (Y), with the first indicator (59) of the second the indicator plate (104) below the second indicator (65) of the second the indicator plate (104) along the second axis (Y), and with one of the first and second indicator plates (102, 104) being selectively and detachably engaged to the recessed portion (100) of the outer face (56) of the slider (14).
